(19) United States
(12) Patent Application Publication
(10) Pub. No.: US 2008/0254417 A1
(43) Pub. Date: Oct. 16, 2008

(54) Driver training system

(76) Inventor: Farzan Mohamed, Baltimore, MD (US)

Correspondence Address: Donald W. Meeker;Patent Agent, 924 East Ocean Front #E, Newport Beach, CA, 92661, US

(21) Appl. No.: 11/786,703

(22) Filed: Apr. 12, 2007

(51) Int. Cl. G09B 9/02

(52) U.S. Cl. 434/69

(57) ABSTRACT

A system and software provides driver training so that a student driver may gain knowledge and experience for passing a driver's license exam as well as allowing a new driver to gain years of experience as well as increasing older drivers instincts and reflexes. The program comprises a game mode, an eye testing station, a driver's safety video, a written test, a driving simulation mode, an actual driving test by the state or county, and a vehicle selection mode.

### CROSS-REFERENCE TO RELATED APPLICATIONS

Not Applicable.

### STATEMENT REGARDING FEDERALLY SPONSORED RESEARCH OR DEVELOPMENT

Not Applicable.

### THE NAMES OF THE PARTIES TO A JOINT RESEARCH OR DEVELOPMENT

Not Applicable.

### BACKGROUND OF THE INVENTION

1. Field of the Invention

The present invention relates to teaching individuals to drive and particularly to a pass or fail point system and software for driver training so that a student driver may gain years of simulation experience and knowledge for passing a driver's license exam, while preparing driver for real life on the road day to day driving situations and or an experienced driver may refresh their skills; the program comprises a game mode, an eye testing station, a driver's safety video, a written test utilizing the actual study book by state, a driving simulation mode utilizing G.P.S technology an again the actual study book, an actual driving test utilizing G.P.S and Google® earth technology so that user can use the actual typography testing area layout by state or county, and a vehicle selection mode or an experienced driver may refresh their skills; the program comprises a game mode, an eye testing station, a driver's safety video, a written test, a driving simulation mode, an actual driving test by the state or county, and a vehicle selection mode.

2. Description of Related Art Including Information Disclosed Under 37 CFR 1.97 and 1.98

The present invention focuses on reducing teenage accidents and road fatalities. Teenage and other young new driver fatalities arising from auto related accidents are higher than any other group. Auto related accidents is the number one cause of teen age fatalities.

The Main Contributing Factors to Young Driver Fatalities Include:
1. Not having enough driving experience as a new driver. (Not having enough defensive driving skills or road experience to avoid hazardous or harmful situations.) Not having enough ears to eye to brain coordination. In February 2007 C.N.N cable network announced that it is a proven fact that a users of software games increased user coordination which makes a user more responsive in relation to ear to eye to brain coordination for quicker responses. Inventor believes that by inference C.N.N findings utilizing the same will decrease road fatalities making a driver more alert.
2. Not wearing seat belts.
Multi-tasking.
3. Eating or drinking when driving.
4. Traveling with other teens (distractions).
5. Talking on the cell phones while driving.
6. Adjusting the radio station or changing a CD.

A survey done in January 2006 by A.A.A. indicated that new drivers contribute 45% of all vehicular accidents. This is due to the fact that inexperienced drivers have not developed learned responses to emergency situations. While older drivers contribute 22% of all vehicular accidents. This is due to slower responses. Any additional coordination such ear to eye to brain contact is guaranteed to improve their driving skills. Driving simulators are known in the art which generate driving situations and impart them to the driver, to enable the driver to experience a feeling as if driving in real life.

A new driver by age sixteen cannot drive on the road prior to turning sixteen and therefore cannot gain the years of experience before getting behind the wheel. Prior art driver simulation devices do not provide sufficient depth or breadth or length of simulated driving experience to provide the driving instincts that years of driving provides. While older drivers have not had any on-going training to keep them at their peak performance. This program allows everyone young and old to utilized at their convenience in the privacy of their home the pass or fail point system utilizing their State Examination test book and G.P.S technology as a safety driving simulator. User will know if he or she should still be driving or if they are ready for the road or to take the actual driving or written simulation test.

Simulators for vehicle driving instruction are known in the prior art, such as U.S. Pat. Nos. D339,387; 3,657,457; 3,898,746; 3,916,534; 4,077,138; 4,383,827; 4,464,117; 4,750,888; 4,846,686; 4,939,587; 5,005,148; 5,044,956; 5,131,848; 5,184,956; 5,707,237 6,270,349; 6,431,872 and 6,652,376.

U.S. Patent Application #20060040239, published Feb. 23, 2006 by Cummins, describes a driving simulator having artificial intelligence profiles, replay, hazards, and other features. The driving simulator may include a processor; a display connectable to the processor; a plurality of input devices, such as a steering wheel, a brake pedal, and an accelerator pedal, where each of the plurality of input devices is connectable to the processor; and a computer-readable medium. The computer-readable medium contains instructions for providing a plurality of simulated driving environments, allowing a user to select one of the plurality of simulated driving environments, allowing a user to provide environment settings, allowing a user to select a simulated vehicle to operate, activating hazards, generating a plurality of simulated vehicles, generating a profile for each of the plurality of simulated intelligent vehicles; randomly assigning spawn points to each of the plurality of simulated intelligent vehicles, displaying the simulated driving environment to a user and allowing the user to operate the simulated vehicle in the simulated driving environment using the plurality of input devices, recording the operation of the simulated vehicle through the simulated driving environment, and replaying the operation of the vehicle.

U.S. Patent Application #20040158476, published Aug. 12, 2004 by Blessinger, claims systems and methods for training students in a tripartite curriculum of ground vehicle learning. The tripartite curriculum includes computer based testing, training on a simulator, and instructor-led classroom training.

U.S. Patent Application #20040224740, published Nov. 11, 2004 by Ball, discloses a competitive simulation game comprising a base program and at least one controllable object controllable by a player, characterized in that, in use, a real time input from a real life game controls a competitive object in the competitive simulation game as a competitor to the player.

U.S. Patent Application #20020052724, published May 2, 2002 by Sheridan, indicates a hybrid vehicle operations simulator that uses an actual mobile vehicle whose operation is to be simulated, combined with computer-based image generation devices, and velocity, acceleration, and/or position measurement tools to improve the simulated operation of the vehicle, including perception of and response to hazards. Using the actual vehicle whose operation is to be simulated improves operator vestibular cues, visual cues, and motion fidelity, thereby producing a safer, less expensive means to produce the simulation.

U.S. Patent Application #20040259059, published Dec. 23, 2004 by Aoki, puts forth an interactive driving simulation apparatus for a two-wheeled vehicle wherein a real-time test drive performance by a student operator around a simulated driving route sequence is recorded. The recorded performance is later replayed for the benefit of the student, to provide real-world simulation, education, and performance evaluation. During the simulated driving, pre-recorded performance evaluation comments are selected and stored, corresponding to the student's specific performance at a traffic driving situation on the driving route sequence. Then, upon displaying of a replay screen image of the simulated driving on a display unit, when a particular traffic driving situation is arrived at, a simulated operating environment of the traffic driving situation and the selected performance evaluation comments are automatically superimposed and displayed together as a replay screen.

U.S. Patent Application #20050182632 published Aug. 18, 2005 by Niyamaru, concerns a simulation apparatus, comprising: a simulated vehicle operable by a driver; a speech recognition section for recognizing speech of the driver; and an outputting section for performing predetermined outputting based on the operation and the speech of the driver; wherein said speech recognition section automatically starts or stops the recognition of speech in response to a situation on simulated driving.

U.S. Pat. No. 4,486,180, issued Dec. 4, 1984 to Riley, is for a system for the administration of driver's tests and similar standardized tests has a computer control unit. A cathode ray tube (CRT) or other display is connected to the computer control unit by line. The display includes at least a numeric input keyboard connected to the remainder of the display by line. A camera or other portrait image registering device is connected to the computer control unit by line. A fingerprint image registering device is connected to the computer control unit by line. At least the display, the portrait image registering device and the fingerprint image registering device are located in a booth having a door. A switch or other detector for an open door prevents a test from being administered or continuing as long as the door is open. A vision testing device is connected to the computer control unit by line. Both a test of knowledge of a state's driving laws and a vision test may be administered by this system.

U.S. Pat. No. 6,227,862, issued May 8, 2001 to Harkness, provides a system and method for providing driver training and education particularly targeted towards teenage drivers. A system and method focus on six major areas that address both driving and lifestyle skills. The six major areas are i) lifestyle, ii) risk and benefit perception, iii) visual search, iv) speed adjustment, v) space management and vi) hazard recognition. The invention is directed to post licensing training and education. Content is embedded in a multi-faceted instructional framework using contemporary learning methods that work with teens using multi-media technologies and integrated and realistic subject matter utilizing three main components, namely workout sessions, computer based training (CBT) and parent-teen activity. The invented system and method encourages and enlists participation of the parents who are recognized as key agents in the development of safe driving practices. There is an ongoing assessment, which provides feedback for remediation. Further, certification provides additional incentive for learning.

U.S. Pat. No. 5,888,074, issued Mar. 30, 1999 to Staplin, shows a system for testing and evaluating driver situational awareness incorporates a device for displaying road and traffic images to a subject being tested, road and traffic image data for simulating operation of a vehicle to be outputted on the display device, instruction data to be outputted at least on the display device, input devices for inputting response data from the test subject in response to road and traffic image data generated on the display means, and a control device for controlling the operation of the system. The control device incorporates a vision test component for conducting a vision test of the subject and a driving reaction test component for conducting a driving reaction test of the subject. Each of the vision and driving reaction tests includes generating road and traffic image data for simulating operation of a vehicle, generating instruction data in coordination with the image data for providing instructions for the subject, monitoring for inputting of response data, and determining whether the inputted response data is correct or incorrect. The generated image data includes road and traffic video image data, test pattern image data and situation test image data. The test pattern image data is structured to test static visual acuity, static visual contrast sensitivity, dynamic visual acuity, dynamic visual contrast sensitivity and angular motion sensitivity. The situation test image data is structured to test divided attention capacity, selective attention capacity, attention switching, working memory functions, brake reaction time, and complex reaction time and decision making.

Four U.S. Pat. No. 5,366,376 issued Nov. 22, 1994; U.S. Pat. No. 5,368,484 issued Nov. 29, 1994; and U.S. Pat. Nos. 5,618,178 and 5,618,179 issued Apr. 8, 1997 to Copperman, claim a driver training system for a user of a simulated vehicle. The system includes input devices for controlling the simulated vehicle, a video display having three-dimensional graphics, modeling software for determining position information based on the input devices, atmospheric effects software to simulate time-of-day and weather conditions, and recursive training software to display a previous route through an environment simultaneously with a present route through the environment together with associated performance data. Another aspect of the recursive training software replays either the previous route or present route and controls one of the input devices to provide “hands-on” feedback to the user. The user then incrementally and recursively maximizes parameters associated with vehicle operation skill. The driver training system may be embodied as a vehicle simulator.

U.S. Pat. No. 5,573,402, issued Nov. 12, 1996 to Gray, describes a driver training system for a user of a simulated vehicle. The system includes input devices for controlling the simulated vehicle, a video display having three-dimensional graphics, modeling software for determining position information based on the input devices, atmospheric effects software to simulate time-of-day and weather conditions, and recursive training software to display a previous route through an environment simultaneously with a present route through the environment together with associated performance data. Another aspect of the recursive training software replays either the previous route or present route and controls one of the input devices to provide “hands-on” feedback to the user. The user then incrementally and recursively maximizes parameters associated with vehicle operation skill. The driver training system may be embodied as a vehicle simulator.

U.S. Pat. No. 5,607,308, issued Mar. 4, 1997 to Copperman, discloses a vehicle simulator with realistic operating feedback. A driver training system for a user of a simulated vehicle is provided which includes input devices for controlling the simulated vehicle, a video display having three dimensional graphics, a computer, modeling software for determining position information based on the input devices, atmospheric effects software to simulate time-of-day and weather conditions, and realistic operating feedback software for simulating on the input devices the feedback normally experienced with operating the vehicle. One aspect of the preferred embodiment is a system including a low frequency speaker mounted on an enclosure adjacent to the simulation user's seat through which road feel cues such as hitting an object are transmitted to the user in response to signals received from the computer. Another aspect of the invention is a system for simulating the feel to the user of anti-lock brakes on a brake pedal in response to signals received the computer.

Two U.S. Pat. No. 5,474,453 issued Dec. 12, 1995 and U.S. Pat. No. 5,660,547 issued Aug. 26, 1997 to Copperman, indicate a vehicle simulator containing a system for development of vehicle simulation scenarios. The vehicle simulation system includes simulated vehicle controls providing input signals to a computer, and feedback devices, including a video display, providing a user feedback on the operation and location of the simulated vehicle as it is driven through a simulated universe. One aspect of the invention is a scenario development system which uses the vehicle controls, the computer and the output devices to enable a scenario developer develop a simulation scenario which includes other programmed vehicles. The scenario developer can determine when and where the other programmed vehicles become active in a simulated universe in which the scenario takes place, as well as determine when and where the programmed vehicles leave the simulated universe. The scenario developer can also program the path of the programmed vehicles through the simulated universe by simply driving the programmed vehicles through the simulated universe using the vehicle controls and the feedback devices on the path that the scenario developer wishes the programmed vehicle to appear.

U.S. Pat. No. 6,361,321, issued Mar. 26, 2002 to Huston, puts forth a dynamically controlled vehicle simulator system, and methods of constructing and utilizing same. The system for simulating the operation of a vehicle comprises a monitor for displaying a sequence of visual images; a plurality of control devices for the simulated vehicle for manipulation by an operator of the simulated vehicle; a computer, responsive to manipulation of the simulated vehicle control devices, for presenting a temporal sequence of visual images to the operator on the monitor which depicts the operation of the simulated vehicle along a roadway in a simulated environment; a mechanism for dynamically controlling weather effects in the simulated environment; and a mechanism for creating a traffic event in the simulated environment on demand during a simulation session and presenting the traffic event to the operator substantially immediately thereafter.

U.S. Pat. No. 5,269,687, issued Dec. 14, 1993 to Mott, illustrates a driver training system for a user of a simulated vehicle. The system includes input devices for controlling the simulated vehicle, a video display having three-dimensional graphics, modeling software for determining position information based on the input devices, and recursive training software to display a previous route through an environment simultaneously with a present route through the environment. The user then incrementally and recursively maximizes parameters associated with vehicle operation skill. The driver training system may be embodied as an arcade game.

What is needed is a driver training system using simulation of actual driving conditions related to diver testing and specific road locations including a combination of specifically focused options of vehicle choice and actual driving location with specific driving information and practice related to the actual driver testing at the location where the actual driving test will take place and a system which provides incentive for use and provides sufficient depth and breadth and length of simulated driving experience to provide the driving instincts that years of driving provides.

### BRIEF SUMMARY OF THE INVENTION

An object of the present invention is to provide a driver training system using simulation of actual driving conditions related to diver testing and specific road locations including a combination of specifically focused options of vehicle choice and actual driving location with specific driving information and practice related to the actual driver testing at the location where the actual driving test will take place and a system which provides incentive for use and provides sufficient depth and breadth and length of simulated driving experience to provide the driving instincts that years of driving provides.

Another object of the present invention is to train both new and senior citizen drivers to become more proficient in every aspects of driving so that by age 16, driving and defensive driving will become instinctual in every aspect of driving and in taking the actual written and or driving test.

A related object of the present invention is that by providing constant visualization of the actual layout of the testing area by State, County, City or Country, as well as utilizing on a day to day basis the actual study book on a pass/fail no tampering electronic point system by state as a driver's safety video, and using the actual study book as a safety 4D driving simulation software video will make a user a proficient and experienced driver by age 16

In brief, a combined set of programs for driver training, proficiency acquisition, and driver testing preparation provides: 1. Breathalyzer test. 2. Eye Testing Station. 3. Driver's safety video (By Department of Transportation for that state). 4. Drug/alcohol testing video/training and certification. 5. Choosing locality for simulation. 6. Choosing vehicle for simulation. 7. Choosing standard shift or automatic shift driver training program. 8. Seat belt control (simulator will not engage without seat belt buckled). 9. GPS Game Mode (utilizing fail or pass point system). 10. Written Test as a drivers study book as a safety 4-D video utilizing pass or fail no tampering electronic point system. 11. Test converted into a driving simulator of actual testing area. 12. Actual Driving test simulation by State, County, City or Country utilizing the actual testing area layout by state, all in 4 D Audio, Video compact disc high definition software. 13. Driving test instruction.

If a permit holder/new driver takes a virtual reality simulation test prior to obtaining a drivers license and if the user fails, scoring 70% or less, then it is evident upfront that this person is a risk without jeopardizing a single life or causing a single accident. Keep in mind that the simulation is based on the actual written test.

A primary advantage of the present invention is that many lives will be saved by training new drivers and retraining older drivers properly including conditioning the drivers to respond effectively in emergency situations and developing as well as continuing on an ongoing basis good driving habits.

Another advantage of the present invention is that a driver will be thoroughly prepared for taking a driving test to obtain a drivers license.

### BRIEF DESCRIPTION OF THE SEVERAL VIEWS OF THE DRAWINGS

These and other details of my invention will be described in connection with the accompanying drawings, which are furnished only by way of illustration and not in limitation of the invention, and in which drawings:

FIG. 1 is a diagrammatic view of the series of programs of the system of the present invention.

### DETAILED DESCRIPTION OF THE INVENTION

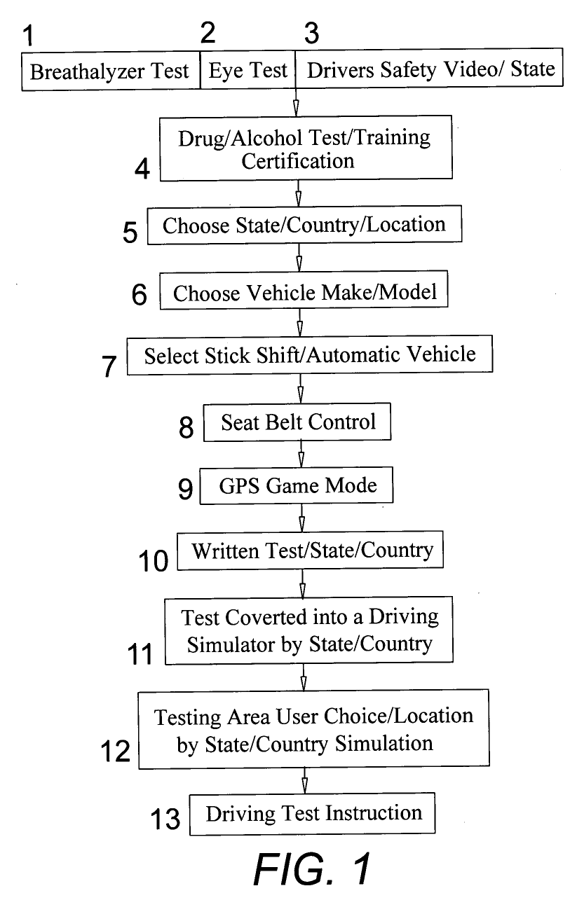

In FIG. 1, a driver training system 20 provides a series of integrated software programs for complete simulation and practice of driving and driver testing to provide incentive for use and sufficient depth and breadth and length of simulated driving experience to provide the driving instincts that years of driving provides.

An actual breathalyzer test 1 makes a user aware of how the test works and can actually be used to reduce drunk driving accidents and road fatalities. This part of the system focuses mainly on preventing someone from driving if they had to much to drink. For example, if people are having a party at their house and someone had too much to drink, but the people are not sure if the drinker should be driving. The drinker will now be able to walk over to the game of the present invention and take an actual breathalyzer test.

An eye testing station 2 with a digital reader enables the user to undergo an actual eye test at the user's convenience, just like taking an eye examination either at the Optometrist or at Department of Motor Vehicles to help the user in the early stages or phases of life as well as trying to obtain or renew their driver's license.

A driver safety video 3 by a driver's state Department of Transportation enables a user to watch to see what can actually happen if driving under the influence, distraction while driving, not following highway laws etc.

A drug, and alcohol testing video training program 4 educates drivers on safe drug-free and alcohol-free driving. A certification program mandatory by most states department of motor vehicles as a continued education for drunk drivers and is also a mandatory requirement by most state department of motor vehicle before a foreign drivers can obtain their learners permit or drivers license.

A test location selection program 5 allows a user to select a state, city, county, and country where actual testing will take place. After selection of country, city or state the actual layout of the testing area can be viewed or selected to enable a user to do the actual driving test with ease when the actual testing day arrive. Knowing the actual topography layout will give user the advantage since driving the actual layout as a game many times in the simulation.

A user inputs into a selection program 6 make a selection of a vehicle and license class, which might include The audio video compact disc software/game will allow the user to select or purchase the vehicle of choice for state licensing. For example, after installation of software a world map would appear. The user will be able to select the country, city, county or state that he or she wishes to pursue a driver's license. After that selection another picture selection of an automatic vehicle, stick shift car, light truck, 18 wheeler, van, boat, forklift, motor cycle or other vehicle will appear for selection.

With each selection, the class will also appear. For example, Class D licensing for cars, small truck and vans. There will also be a selection of a Big Rig for C.D.L heavy duty trucking, selection of a motor cycle for Class C, selection of a boat for boating or captain license, and selection of a forklift for licensing.

The user chooses between a standard transmission and an automatic transmission driver training program 7. There will be a special emphasis on stick shift and handicap vehicles. For instance, shift now, a flashing light on the dash will remind you to shift: “Be careful you might burn the clutch if you do not shift on time.” (Software will assist and advised user when shifting is necessary.)

A seat belt control 8 requires a user to buckle up a seat belt in order to activate the system and the program will not engage in any aspect until the seat belts is fasten. This required fastening of a seat belt to use the system if practiced in the game mode by users from age 5 to 16, when the user does obtain a drivers license at age 16, buckling the user's seat belt will become automatic and second nature since new driver not wearing seat belt is the second biggest factor resulting in teenage road fatalities.

A Global Positioning System (GPS) driving simulation program 9 comprises a driving simulation game mode for carrying out enforcement of state and country driving laws including tickets and driving points issued for not following chosen state driving laws, wherein driver safety, defensive driving, and simulation hours of training are the main focus with a no tampering electronic pass/fail point system. This program will insure parents that their love ones are road ready while also insuring M.V.A that the driver has met additional safety requirements up and beyond theirs.

The G.P.S. game mode 9 comprises using a G.P.S. program to simulate an actual roadway at a selected location and further comprises programmed driving conditions, and a no tampering electronic pass/fail point system to evaluate performance in driving over the roadways. This enables a user to become more familiar with areas that are not familiar to the user. By utilizing G.P.S technology along with the software of the present invention, the user can now simulate the actual drive prior to driving down a roadway. For example, a user is going to be traveling to Las Vegas and renting a car at the airport. After renting a vehicle the user will be driving to the M.G.M Grand hotel. The user can now practice and drive the actual streets by utilizing the virtual reality simulator and simulate the actual drive while also getting familiar with the actual highways and streets. This feature will not just save lives but will expedite the actual trip. A pass/fail no tampering electronic point system is also part of this simulation program so a user can become more proficient on safety and road regulations.

An actual written test 10 by state or country is electronically graded and includes a no tampering electronic pass or fail grading system.

The written test is converted into a driving simulator 11 comprises an actual 3D street type driving program by selection of state, city, county to produce a simulation of the actual location of the real driving test and utilizing a pass/fail point system taking into account applicable laws to the state chosen and other driving road conditions and hazardous situations encountered in driving. The driving conditions may comprise at least one of the following conditions including hazardous roadway conditions, hazardous roadway situations including bad in-experienced and drunk drivers, inside vehicle distractions, and different climate and road conditions. The inside vehicle distractions may be considered multitasking and or may comprise teenagers driving with other teenagers, adjusting radio stations, changing CDs, eating, and talking on cell phones.

The actual written test and/or study book test from each city, state, county, country is transformed into an actual drivers safety video, utilizing a no tampering electronic pass/fail point system. The user will begin by using a life-like driving simulator in our program with 100 points being allocated. Points will be deducted for being pulled over by a police officer. At which time a citation will be issued as well as a fine being imposed on driver. Each time a citation is issued, the user will also have additional points deducted from his/her drivers license at which time the drivers license can also be revoked. Points and revocation of license will be the same as in the state chosen.

Points are deducted each time a user fails to follow the safety requirements of that state (for example not pulling over if an emergency vehicle with flashing lights is behind the vehicle) This is done so that the user will have a first hand, true life visual of that state's actual written test and what follows in terms of consequences if safety and defensive methods are not utilized when driving. This will allow the user to gain years of defensive driving experience, again conditioning the user in being familiar with the written test as well as any safety regulations mandated by the state to help the user to understand how to or when to apply the actual state written test in their real life driving experience, so that in the event of an actual emergency or if difficult situations do arise, the user will have effective driving defensive instinct from the simulation/training which will automatically kick in, since they have done this so many times for so many years in the simulations. When the user reaches a 70 point mark, the game will cancel causing the user to fail the drivers test and the game must be restarted.

A global positioning satellite (G.P.S) testing simulation mode 12 comprises using a G.P.S. program to simulate an actual driver testing location for a user to practice driving over the testing location.

A driving test instruction program 13 provides point by point instruction about the actual driving test.

The present invention enables a user to simulate actual diving experiences while gaining years of defensive driving experience prior to actually driving.

The system may further comprise a stand-alone vehicle replica with all features and operational functions of a real vehicle interconnected with a global positioning satellite program and screen to simulate driving on actual roadways.

In addition to the written test simulation program, special emphasis will focus on repeated simulated experience so that automatic responses will kick in when actual dangerous driving situations do arise in an actual vehicle.

In addition to the written test as a safety video, other unsafe situation simulations will be added such as when driving along side an 18 wheeler carrying logs, the logs suddenly brake loose, entering a tunnel when the sun is at the height of the tunnel therefore while entering there is a blind spot just as the driver enters but there is a stalled vehicle in your lane, coming out of a parking lot or side street with no visual site line of oncoming traffic due to parked cars blocking the driver's view.

The present invention includes an audio video 3D game version game program that can be use on any existing Play Station, Game Boy, Game Cube, X-Box, Nintendo 64, Desk top or Lap top Computer or, the ultimate, a standalone vehicle replica go cart design to either move with powered wheels or just as a standalone unit equipped with a 5″ to 9″ monitor, DVD player and/or built in computer hard drive.

The program can produce a Virtual Reality Simulator style (4 D life like graphics) utilizing a pass/fail no tampering electronic point system. The software design setup may allow a user's choice to selection levels 1-9, depending on the previous passing of the levels (levels cannot be bypassed).

In use, in the game program, the new driver will be allowed 100 points. When the driver fail to follow that state required safety study book safety video while driving simulation style, for example not wearing seat belts, not pulling over if a emergency vehicle is approaching, points will be deducted. Overtaking while driving up a hill points will be deducted. A new driver obtaining a learners permit must have a passing score of 65% with 100% being the highest.

If driver fail the virtual driving test, a re-testing must be re-scheduled. And before the actual license is awarded the same proposed driver utilizing the same virtual simulator taking the same simulation test must have a passing score of 95%. Making this mandatory before a new driver gets his or her driver's license is sure to decrease teen age accidents and road fatalities. This program if utilized before a new driver's license is issued is guaranteed to save lives.

The software being either a 3-D or 4-D design program of the present invention will add years of driving experience to any driver, since it is a proven fact that “practice makes perfect”. And since the tamper free no fault electronic point system of the present invention is accurate.

The user will be able to select the different types of license they wish to obtain by selecting the State or Country, utilizing and taking the actual written sample test as well as visualization of the actual layout when taking the actual driving test in a 3D mode simulation.

The present invention will be for all ages. Ages 3 to 13 years can use the same pass or fail no tampering electronic point system program as a game on the play mode by selecting various highways in the city, states, county or country or they wish to drive utilizing pre-loaded maps from G.P.S navigation technology. A selection for weather climate can be chosen.

Ages 14 to 16 years can use the game mode of the present invention as a simulation mode to practice defensive driving, since the present invention converts and utilizes the actual book study questions into a 3-D driving simulator or just to study for the upcoming written test. Ages 35, 40 or 50 years of age can use this game to brush up their driving skills while keeping up with new state or international laws. Special emphasis will also be focus on older drivers 50 and above, this program will increase an assure greater reflexes since it is also a proven fact that Game software increases ear to eye to brain coordination.

Whether a user is just looking for entertainment on the play mode, acquiring a new learner's permit and or just renewing or brushing up on current laws or legislation changes, this CD program/software game will assure hours of fun and entertainment while insuring parents that through the present invention no tampering electronic point system their child have undergone the many hours of defensive training which will now add years of experience to a new driver by age 16 without leaving the house.

The software of the present invention will also be voice activated for the handicapped as well as being able to select specially designed handicap vehicles.

In the driving modes the driver or user will be given driving tips. For example, when driving in the snow, the user will be prompted to lower air pressure for better traction and steer in the direction of the slide. For better gas mileage check tire pressure for no more than recommended tire pressure. How to change a tire or where the tire and jack is located in their vehicle. How to change or check oil.

A user can purchase a vehicle from the software link of the present invention to local car dealers. The user can now select the type of vehicle they desire as well as choosing the instructor by picture and or name if given permission by these individuals. Or if sponsorship by a particular Vehicle manufacturer is taken, the user will only be able to purchase that manufacturer vehicle by going the actual dealer web site by state and viewing inventory to either make an actual purchase or a game purchase. If an actual purchase is going to be made by user the user can then select as such at which time will be taken through the application and approval process.

It is understood that the preceeding description is given merely by way of illustration and not in limitation of the invention and that various modifications may be made thereto without departing from the spirit of the invention as claimed.

What is claimed is:

1. A driver training system for complete simulation and practice of driving and driver testing, the system comprising:
a breathalyzer test to reduce drunk driving accidents and road fatalities;
an eye testing station having a digital reader enables the user to undergo an actual eye test prior to taking an actual vision test to obtain a drivers license;
a driver safety video by a user's choice state Department of Transportation;
a drug, and alcohol testing video training to educate drivers in safe driving;
selection of state, city, county, and country where actual testing will take place;
selection of a vehicle and license class;
a seat belt control requires a user to buckle up a seat belt in order to activate the system;
a global positioning satellite (G.P.S) game mode comprising using a G.P.S. program to simulate an actual roadway at a selected location and further comprising programmed driving conditions carrying out enforcement of state and country driving laws including tickets and driving points issued for not following chosen state driving laws, wherein driver safety, defensive driving, and simulation hours of training are the main focus, and an electronic tamper proof pass/fail point system;
an actual written test by state or country electronically graded and include a pass or fail electronic no tampering grading system;
a written test converted into a driving simulator comprising an actual 3D street type driving program by selection of state, city, county to produce a simulation of the actual location of the real driving test and utilizing a pass/fail point system taking into account applicable laws to the state chosen and other driving road conditions and hazardous situations encountered in driving;
a global positioning satellite (G.P.S) testing simulation mode comprising using a G.P.S. program to simulate an actual driver testing location for a user to practice driving over the testing location;
a program providing point by point instruction about the actual driving test;
thereby enabling a user to simulate actual diving experiences while gaining years of defensive driving experience prior to actually driving.

2. The system of claim 1 further comprising a stand-alone vehicle replica with all features and operational functions of a real vehicle interconnected with a global positioning satellite program and screen and modern to simulate driving on actual roadways as well as a memory card to repeat pass performance.

3. The system of claim 1 wherein the driving conditions comprise at least one of the following conditions including hazardous roadway conditions, hazardous roadway situations including aggressive and in-experienced drivers, inside vehicle distractions, and different climate conditions.

4. The system of claim 4 wherein the inside vehicle distractions comprise teenagers driving with other teenagers, adjusting radio stations, changing CDs, eating, and talking on cell phones.
